(19) United States
(12) Patent Application Publication
(10) Pub. No.: US 2011/0076005 A1
(43) Pub. Date: Mar. 31, 2011

(54) PORTABLE ELECTRONIC DEVICE HAVING CAMERA

(75) Inventor: MING-LUNG GUO, Tu-Cheng (TW)

(73) Assignee: HON HAI PRECISION INDUSTRY CO., LTD., Tu-Cheng (TW)

(21) Appl. No.: 12/756,115

(22) Filed: Apr. 7, 2010

(30) Foreign Application Priority Data
Sep. 25, 2009 (CN) 200910307682.X

(51) Int. Cl. G02F 1/00

(52) U.S. Cl. 396/457

(57) ABSTRACT

A portable electronic device includes a first cover, a second cover, a camera and a liquid crystal shutter. The first and second covers cooperatively form a housing. The camera is received in the housing and fixed to the first cover. The camera includes an optical lens and an image sensor. The optical lens is optically aligned with the image sensor. The second cover has a through hole defined therein aligned with the optical lens of the camera. The liquid crystal shutter is fixed in the through hole. The liquid crystal shutter is changeable between a bright state and a dark state, thereby having a light switch function of a shutter.

### BACKGROUND

1. Technical Field

The present disclosure relates to a portable electronic device having a camera.

2. Description of Related Art

In recent years, portable electronic devices, such as mobile phones with cameras have become more and more widely used. A typical camera used in the portable electronic device is equipped with a shutter, and an image sensor such as a charge coupled device (CCD) or a complementary metal-oxide semiconductor (CMOS) sensor, which is exposed automatically at a predetermined shutter speed.

A conventional camera adopts a mechanical shutter, which uses an arrangement of spring, cam and gear to control the speed of the shutter. However, the shutter has a complex structure and occupies a large amount of space in the camera. This may increase the size of the portable electronic device having the camera.

Therefore, a portable electronic device having a camera which can overcome the above-mentioned problems is desired.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the views.

FIG. 1 is a partially disassembled isometric view of a portable electronic device in which a camera and a liquid crystal shutter are implemented according to an exemplary embodiment.

FIG. 2 is a schematic, isometric view of the portable electronic device of FIG. 1.

FIG. 3 is a sectional view taken along line III-III, showing a plurality of structures of the camera and the liquid crystal shutter of FIG. 1.

FIG. 4 is a sectional view of the liquid crystal shutter of FIG. 3, in which a control circuit is further comprised.

### DETAILED DESCRIPTION

Various embodiments will now be described in detail below with reference to the drawings.

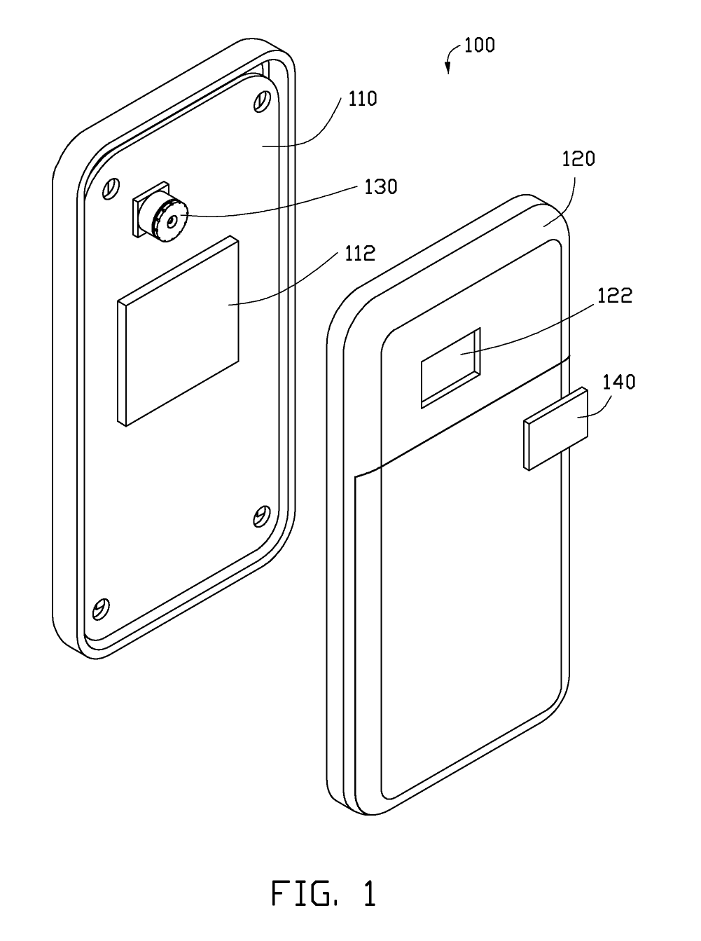

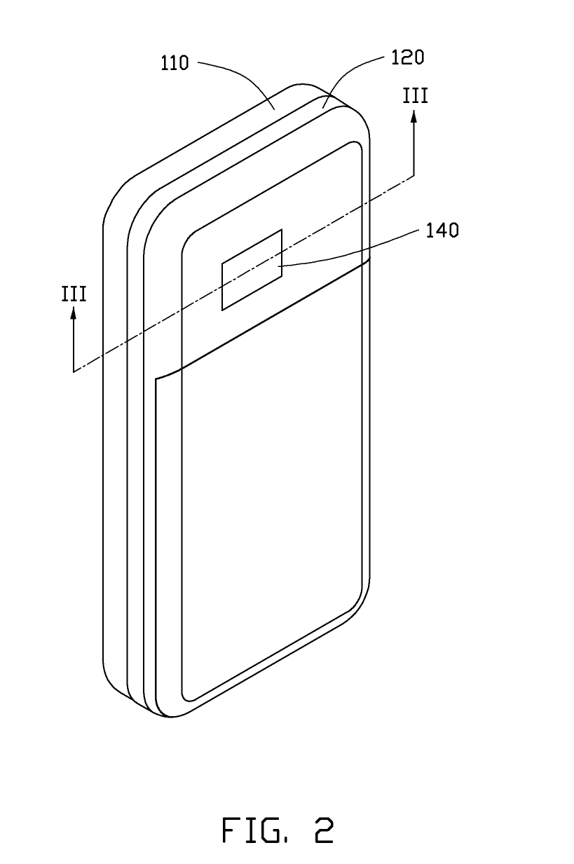

Referring to FIGS. 1 and 2, a portable electronic device 100 in accordance with an exemplary embodiment is provided. In this embodiment, the portable electronic device 100 is a mobile phone. It is noteworthy that the portable electronic device 100 can also be a MP3, a notebook computer, a personal digital assistant (PDA), etc. The portable electronic device 100 includes a front cover 110, a back cover 120, a camera 130 and a liquid crystal shutter 140 for the camera 130. The front cover 110 is connected to the back cover 120, thereby cooperatively forming a housing of the portable electronic device 100.

The portable electronic device 100 further includes a main circuit board 112 received in the housing, and the main circuit board 112 is fixed to the front cover 110. The main circuit board 112 is configured for controlling various functions of the mobile phone, including operations of the camera 130 and the liquid crystal shutter 140.

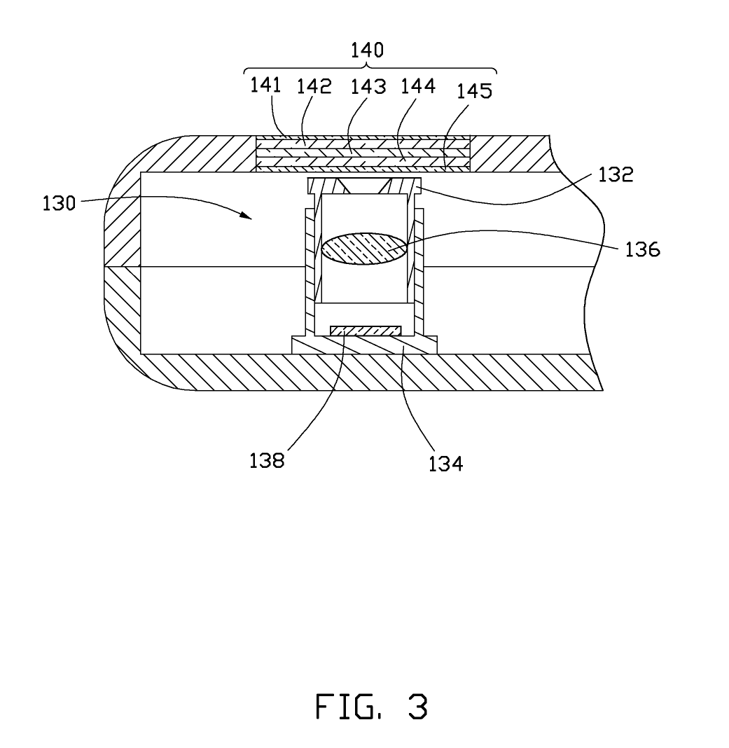

The camera 130 is also received in the housing and fixed to the front cover 110. The camera 130 is electrically connected to the main circuit board 112, thereby is being controlled by the main circuit board 112 to capture images. Referring also to FIG. 3, the camera 130 includes a lens barrel 132, a barrel holder 134, an optical lens 136 received in the lens barrel 132, and an image sensor 138 optically aligned with the optical lens 136. The lens barrel 132 is partly received in the barrel holder 134 and is movable along an optical axis of the optical lens 136 relative to the barrel holder 134. The image sensor 138 is fixed to the barrel holder 134. The image sensor 138 can be a complementary metal-oxide semiconductor (CMOS) or a charge coupled device (CCD). It is to be understood that the number of the optical lens 136 can be more than one, as long as the images of objects can be focused on the image sensor 138.

The back cover 120 has a through hole 122 defined therein. In this embodiment, the through hole 122 is rectangular. The through hole 122 is located facing the camera 130. The lens barrel 132 is adjacent to the through hole 122 such that ambient light passing the through hole 122 can transmit through the optical lens 136 and then onto the image sensor 138. The liquid crystal shutter 140 is positioned in the through hole 122 and fixed to the back cover 120. In an alternative embodiment, the liquid crystal shutter 140 is fixed to the back cover 120 in a manner such that the side surface of the liquid crystal shutter 140 is adhered to an inner wall of the back cover 120 in the through hole 122. The liquid crystal shutter 140 is used as a shutter structure of the camera 130. In addition, the liquid crystal shutter 140 can prevent dust from entering the camera 130.

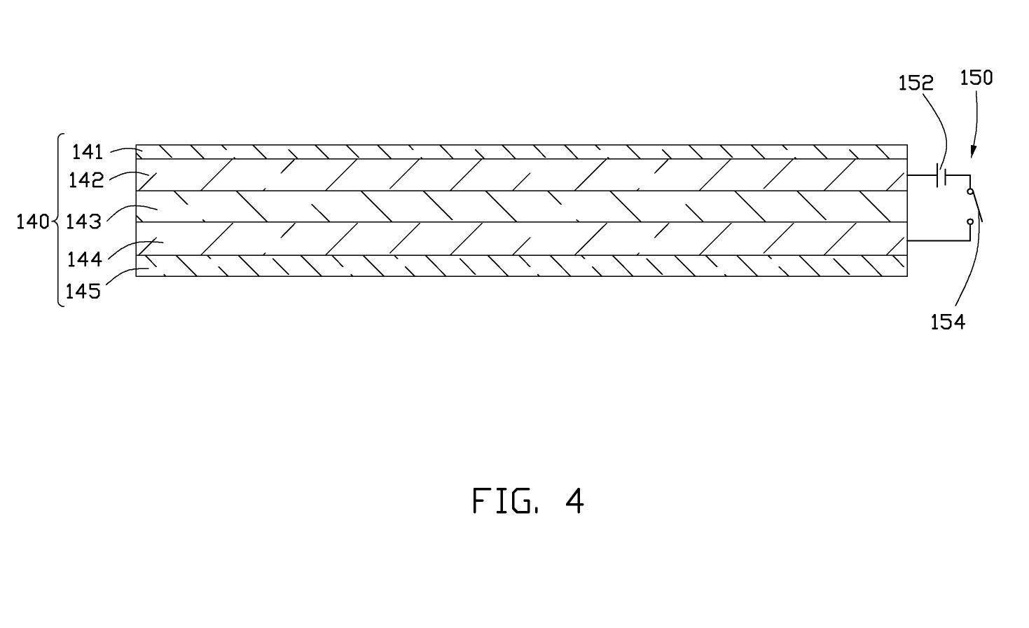

Referring to FIG. 4, the liquid crystal shutter 140 includes a first polarizer 141, a first light-pervious electrode 142, a liquid crystal layer 143, a second light-pervious electrode 144 and a second polarizer 145 sequentially stacked in an order from a position away from the camera 130 to a position closer to the camera 130. In this embodiment, the first and second light-pervious electrodes 142 and 144 are plate electrodes covering the entire area of the liquid crystal shutter 140. In this embodiment, each of the first and second light-pervious electrodes 142 and 144 includes a light-pervious plate and a light-pervious conductive film coated on the light-pervious plate. The light-pervious conductive film can be comprised of indium tin oxide. In an alternative embodiment, the liquid crystal layer 143 is a twisted-nematic type (TN type). The first polarizer 141 has a polarization axis perpendicular with that of the second polarizer 145.

The liquid crystal shutter 140 further includes a control circuit 150. The control circuit 150 is electrically connected to the first and second light-pervious electrodes 142 and 144 for controlling a voltage between the first and second light-pervious electrodes 142 and 144. The control circuit 150 includes a voltage supply 152 and a switch 154 connected in series. The switch 154 is configured for switching on/off of the voltage supply 152. Preferably, a voltage applied to the liquid crystal layer 143 between the first and second light-pervious electrodes 142 and 144 is larger than the saturation voltage of the liquid crystal layer 143. The control circuit 150 can be integrated in the main circuit board 112. In this case, a battery of the portable electronic device 100 can act as the voltage supply 152 of the liquid crystal shutter 140.

When the switch 154 is in an on state, a voltage is applied between the first and second light-pervious electrodes 142 and 144. Thus, orientations of the liquid crystal molecules of the liquid crystal layer 143 tend to become parallel with an electric field direction. When the voltage applied between the two electrodes 142 and 144 is larger than the saturation voltage of the liquid crystal layer 143, orientations of the liquid crystal molecules of the liquid crystal layer 143 are parallel with that voltage, i.e. perpendicular with the first and second electrodes 142 and 144. Light transmitting through the first polarizer 142 becomes linear polarized light. Then the linearly polarized light is transmitted through the liquid crystal layer 143 and keeps the polarization direction unchanged. Because the polarization axis of the second polarizer 145 is perpendicular with that of the first polarizer 141, the light transmitting through the liquid crystal layer 143 is blocked by the second polarizer 145. Here the liquid crystal shutter 140 is in a dark state. That is, the ambient light is blocked by the liquid crystal shutter 140.

When the switch 154 is in an off state, no voltage is applied between the first and second light-pervious electrodes 142 and 144, the liquid crystal layer 143 thereby returns to its original orientations of the liquid crystal molecules. It is known by those skilled in the art that TN type liquid crystal layer can cause a polarization direction of linearly polarized light to rotate 90°. Thus, a polarization direction of the light passing the first polarizer 141 is rotated 90° by the liquid crystal layer 143. That is, the light passing the liquid crystal layer 143 has a polarization direction parallel with the polarization axis of the second polarizer 145. Thus, the light can be transmitted through the second polarizer 145, then passed through the optical lens 136 and finally onto the image sensor 138. Here the liquid crystal shutter 140 is in a bright state. Therefore, the liquid crystal shutter 140 has a light switch function, thereby acting as a shutter structure.

It is noteworthy that the polarization axis of the first polarizer 141 can also be parallel with that of the second polarizer 145. Accordingly, the light is blocked by the liquid crystal shutter when the switch is in an off state, and the light is passed through the liquid crystal shutter when the switch is in an on state. In addition, the liquid crystal layer 143 can be, other types of liquid crystal instead, such as a super twisted nematic (STN) type. Furthermore, the liquid crystal shutter 140 can also be fixed to the front cover 110. Accordingly, the camera 130 is fixed to the back cover 120.

The portable electronic device 100 of the exemplary embodiment includes a liquid crystal shutter 140 fixed to a cover of the portable electronic device 100. Thus the liquid crystal shutter 140 does not occupy any space inside the camera 130. In addition, the liquid crystal shutter 140 merely comprises a multi-layer structure and is replaced in lieu of a dust-proof window for the camera 130. Therefore, the portable electronic device 100 comprising the liquid crystal shutter 140 has a simpler structure and a smaller size.

It is to be understood that the above-described embodiments are intended to illustrate rather than limit the disclosure. Variations may be made to the embodiments without departing from the spirit of the disclosure. The above-described embodiments illustrate the scope of the disclosure but do not restrict the scope of the disclosure.

1. A portable electronic device, comprising:
a first cover;
a second cover, the first and second covers cooperatively forming a housing;
a camera received in the housing and fixed to the first cover, the camera comprising an optical lens and an image sensor aligned with the optical lens, the optical lens being adjacent to the second cover; and
a liquid crystal shutter,
wherein the second cover having a through hole defined therein aligned with the optical lens, the liquid crystal shutter fixed in the through hole, the liquid crystal shutter being changeable between a bright state and a dark state, thereby having a light switch function of a shutter.

2. The portable electronic device of claim 1, wherein the liquid crystal shutter comprises a first polarizer, a first light-pervious electrode, a liquid crystal layer, a second light-pervious electrode, and a second polarizer sequentially stacked.

3. The portable electronic device of claim 2, further comprising a main circuit board for controlling the functions of the mobile phone.

4. The portable electronic device of claim 3, wherein the liquid crystal shutter further comprises a controlling circuit for controlling a voltage between the first and second electrodes.

5. The portable electronic device of claim 4, the controlling circuit of the liquid crystal shutter is integrated in the main circuit board.

6. The portable electronic device of claim 2, wherein a polarization axis of the first polarizer is parallel with a polarization axis of the second polarizer.

7. The portable electronic device of claim 2, wherein a polarization axis of the first polarizer is perpendicular with a polarization axis of the second polarizer.

8. The portable electronic device of claim 2, wherein the liquid crystal layer is a twisted nematic type or a super twisted nematic type.

9. The portable electronic device of claim 1, the camera further comprises a lens barrel and a barrel holder, the optical lens received in the lens barrel, the lens barrel partly received in the barrel holder, and the image sensor fixed to the barrel holder.
